(19) United States
(12) Patent Application Publication
(10) Pub. No.: US 2019/0195366 A1
(43) Pub. Date: Jun. 27, 2019

(54) Mechanical Seal and Device with Such a Mechanical Seal

(71) Applicant: KACO GmbH + Co. KG, Kirchardt (DE)

(72) Inventor: Pascal von Dobrzewinski, Heidelberg (DE)

(21) Appl. No.: 16/222,139

(22) Filed: Dec. 17, 2018

(30) Foreign Application Priority Data
Dec. 21, 2017 (DE) 10 2017 012 105.2

(51) Int. Cl. F16J 15/36

(52) U.S. Cl. CPC F16J 15/36

(57) ABSTRACT

A mechanical seal has a first sealing ring with sliding surface contacting a second sealing ring to form a sealing gap. An elastically deformable membrane is connected to the first sealing ring at a connecting location and covers an end face of the first sealing ring. The membrane has a side that is facing a medium space to be sealed and is loaded by pressure in the medium space. The membrane has a cone section adjoining the connecting location. The cone section, in an unloaded state, has an axial spacing to the end face of the first sealing ring such that the cone section by elastic deformation contacts more or less, as a function of the pressure in the medium space, the end face of the first sealing ring so that a ratio between a gap-opening force and a gap-closing force is adjusted at the sealing gap.

### BACKGROUND OF THE INVENTION

The invention relates to a mechanical seal with at least one sealing ring that is contacting a second sealing ring with formation of a sealing gap and is connected to an elastically deformable membrane that covers an end face of the sealing ring and is pressure-loaded at a side that is facing away from the sealing ring. The invention further relates to a device, in particular a coolant pump, turbocharger, crankcase or gearbox of a vehicle, comprising at least one medium space that is sealed by a mechanical seal.

Mechanical seals are used in many applications in order to seal different types of media such as air, exhaust gases, water, glycol-based mixtures, oil and the like. Such mechanical seals are widely used in particular in water pumps.

One embodiment of such mechanical seals are gas-lubricated mechanical seals. Aerodynamic structures in the sealing gap create an air cushion between the sliding partners and ensure thus a practically friction-free operation.

Moreover, there exist mechanical seals with hydrodynamically acting structures that enable conveyance and return conveyance of fluids into the sealing gap. With proper configuration, friction and leakage can be minimized.

Conventional mechanical seals are comprised of a plurality of parts. They have a sliding ring and a counter ring. The sliding ring is pressed by means of a spring axially against the counter ring. Between the sliding ring and its housing, there is a secondary seal that is usually embodied by O-rings, X-rings, and the like. It is also known to use an elastically deformable bellows as a secondary seal.

The large number of parts of conventional mechanical seals leads to high costs and to a high complexity in regard to the product-related processes. The secondary sealing elements cause additional friction forces that, due to different tolerances of the components, lie within a broad tolerance field. When using O-rings, X-rings, and the like, the friction forces are additionally reinforced so that they vary within a wide range, in addition to the tolerance effects. Greatly fluctuating friction forces or friction forces that are too high can cause faulty positioning of the sliding ring. In an extreme situation, the sliding partners do not separate from each other at all or the sliding ring will be unhinged so that the sealing gap is no longer closed. These effects apply in particular in case of gas-lubricated mechanical seals and can lead to failure of the entire system.

Mechanical seals are known (US 2013/0161912) in which a bellows is used as a secondary element. The friction state depends only on the inner friction states of the bellows. A friction effect as a result of manufacturing tolerances does not exist. However, such mechanical seals are relatively expensive and complex. The functions of axial force application and of sealing by means of secondary seal are separate. By pressure effects, the bellows is deformed and axial force components, primarily tensile forces, are generated. The sum of the axial forces is however dominated by the spring that is substantially independent of operating states. Thus, it is ensured that the seal closes reliably and fulfills its function in all operating states.

Moreover, mechanical seals are known in which an elastically deformable bellows achieves the spring action and sealing action of a secondary seal (DE 10 2004 035 658 B4). The complexity and number of components are reduced and costs of the products and of manufacture can be saved. Due to the omission of a classical spring for axial force application, the axial force is applied exclusively by the elastically deformable bellows. The axial force is thus dependent substantially on the deformation state of the bellows. In particular, when pressure is applied, deformations may result that have a negative effect on the function of the seal.

Another mechanical seal is disclosed in DE 10 2016 006 106 and comprises a membrane with which one sealing ring is pressed axially against the other sealing ring and which serves as a sealing element and a spring element. The membrane is arranged such that it is curved away from the sealing ring by the medium pressure.

The behavior under pressure is a disadvantage in case of the known mechanical seals. The occurring pressure causes tensile loads on the bellows. This causes a stiffening of the spring properties of the bellows and strong loads acting at the connecting location between the bellows and the sliding ring. Also, the tensile load in the bellows can generate an axial force component that is so great that the seal opens and will fail in its function.

The invention has the object to configure the mechanical seal of the aforementioned kind as well as the device in such a way that strong tensile loads in the membrane (bellows) are at least reduced and a high load on the connecting locations between the membrane and the sealing ring is reduced or completely prevented. In addition, a force balance or pressure balance of the gap-opening and the gap-closing forces is to be achieved in a simple way and the pressure distribution in the sealing gap is to be configured in a beneficial way.

### SUMMARY OF THE INVENTION

This object is solved for the mechanical seal of the aforementioned kind in accordance with the invention in that the membrane has a cone section adjoining the connecting location, wherein the cone section, in an unloaded state, has such an axial spacing relative to the end face of the sealing ring that the cone section, as a function of the pressure in the medium space, by elastic deformation contacts more or less the end face of the sealing ring and in this way the ratio between a gap-opening force and a gap-closing force is adjusted at the sealing gap.

This object is further solved for the device of the aforementioned kind in that the device comprises a mechanical seal according to the invention.

The mechanical seal according to the invention is thus characterized in that the membrane is pressure-loaded at its side which is facing away from the sealing ring. This causes an elastic deformation of the membrane as a function of the pressure. The membrane can be configured such that the gap-closing forces acting on the sealing gap can be affected by the elastic membrane deformation such that an advantageous ratio between gap-opening and gap-closing forces at the sealing gap results. The membrane comprises a cone section adjoining a first connecting location. In an unloaded state, the cone section has an axial spacing relative to the end face of the sealing ring such that the cone section, as a function of the pressure in the medium space, by elastic deformation contacts more or less the end face of the sealing ring. In this way, the ratio between a gap-opening force and a gap-closing force is adjusted at the sealing gap.

Connecting the membrane to the sealing ring can be realized in the region of the greatest diameter or of the smallest diameter of the membrane.

A particularly advantageous connection between the membrane and the sealing ring results when the membrane is connected by means of a clamping sleeve to the sealing ring. The connection can also be realized as a material-fused connection, in particular by glueing.

Preferably, the membrane is connected to an end face of the sealing ring that is positioned opposite the sliding surface. In this way, the connection between the membrane and the sealing ring can be produced easily.

The attachment of the membrane at this end face of the sealing ring can be realized in the radially outer region or in the radially inner region.

By means of the membrane, the sealing ring can be connected to a housing or to a holding part of the mechanical seal. The housing or the holding part are arranged stationarily so that the sealing ring does not rotate in use of the mechanical seal.

In principle, it is however also possible to connect the sealing ring by means of the membrane fixedly to a holding part that is connected to the shaft. Then the sealing ring rotates about its axis in use.

When the membrane is connected to the end face of the sealing ring, the sealing ring extends away from the connecting location in radial direction outwardly or inwardly, depending on whether the connecting location is located in the radial inner region or in the radial outer region of the end face of the sealing ring.

In an advantageous embodiment, the membrane comprises a cone section which is extending between the connecting locations at the sealing ring and at the housing or at the holding part. This cone section that is positioned between the two connecting locations can be selected with regard to radial width, cone angle, thickness of this cone section as well as material of the cone section in such a way that the gap-closing force, generated by elastic deformation of the cone section and acting in the sealing gap, is provided so that an optimal proportion relative to the gap-opening force is produced. The cone angle, the radial width of the cone section, the thickness of the cone wall section as well as its material can be adjusted in combination such that this advantageous magnitude of the gap-closing force will result. In this way, it is possible to adjust the mechanical seal optimally to the intended situation of use.

In principle, it is sufficient when the mechanical seal comprises only one sealing ring. It is then interacting in the installed position with a corresponding second sealing ring which is provided in the device and which may be formed, for example, by a component of the device itself.

In another advantageous embodiment, the mechanical seal is provided with a second sealing ring. In this case, the two sealing rings of the mechanical seal are resting against each other under axial force and can be installed together with the mechanical seal in a corresponding device.

In general, by means of the design of the contour of the end face of the sealing ring, the force path of the gap-closing force can be positively affected.

In an advantageous embodiment, this end face, where the membrane may come to rest when elastically deformed, passes by a slanted portion or by a step into an outer wall surface of the sealing ring. The slanted portion can be designed in various ways, depending on the application for which the mechanical seal is intended.

The device according to the invention that is in particular a coolant pump, a turbocharger, a crankcase or a gearbox of a vehicle is provided with the mechanical seal according to the invention. The mechanical seal ensures that a proper sealing action is provided.

The subject matter of the application results not only from the subject matter of the individual claims but also from all specifications and features disclosed in the drawings and in the description. They are claimed as being important to the invention even if they are not subject matter of the claims, inasmuch as, individually or in combination, they are novel relative to the prior art.

Further features of the invention result from the additional claims, the description, and the drawings.

The invention will be explained in more detail in the following with the aid of embodiments illustrated in the drawings.

### BRIEF DESCRIPTION OF THE DRAWING

FIG. 1 shows a mechanical seal of the invention in an axial half section.

FIG. 2 shows in an illustration corresponding to FIG. 1 a further embodiment of the mechanical seal of the invention.

FIG. 3 shows in an illustration corresponding to FIG. 1 yet another embodiment of the mechanical seal of the invention.

FIG. 4 shows the mechanical seal according to the invention according to FIG. 1 in the installed state sealing a medium space.

FIG. 5 shows in axial half section a seal arrangement according to the invention that comprises two sealing rings.

FIG. 6 shows in half section a further embodiment of a mechanical seal according to the invention.

FIG. 7 shows in half section a further embodiment of a mechanical seal according to the invention.

FIG. 8 shows, also in half section, a further embodiment of the mechanical seal according to the invention.

FIG. 9 shows another embodiment, in half section, of the mechanical seal according to the invention.

### DESCRIPTION OF THE PREFERRED EMBODIMENTS

The mechanical seals described in the following are configured such that the gap-closing forces between the sealing rings can be affected by a membrane deformation.

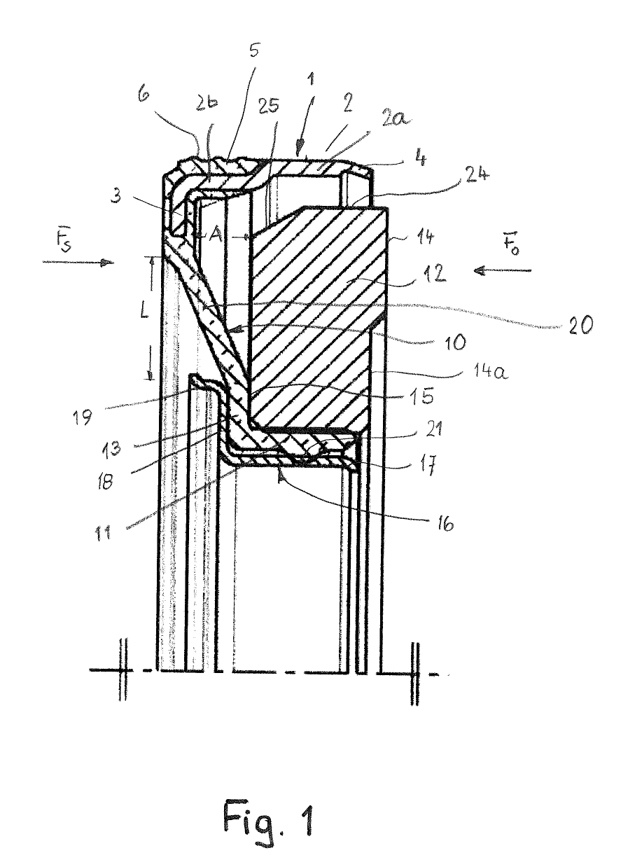

The mechanical seal has an annular housing 1 (FIG. 1) that may be comprised of metal, of a hard plastic material, or a composite material. The housing 1 has an approximately L-shaped cross section and comprises a cylindrical annular part 2 which in the embodiment is comprised of two ring sections 2a, 2b that are radially displaced relative to each other and are each cylindrically embodied. The ring section 2b that is smaller in regard to diameter passes at its free end into an annular flange 3 that is oriented radially inwardly.

The free end of the ring section 2a which is greater in diameter can be provided with an angled portion 4 which is oriented at a slant inwardly.

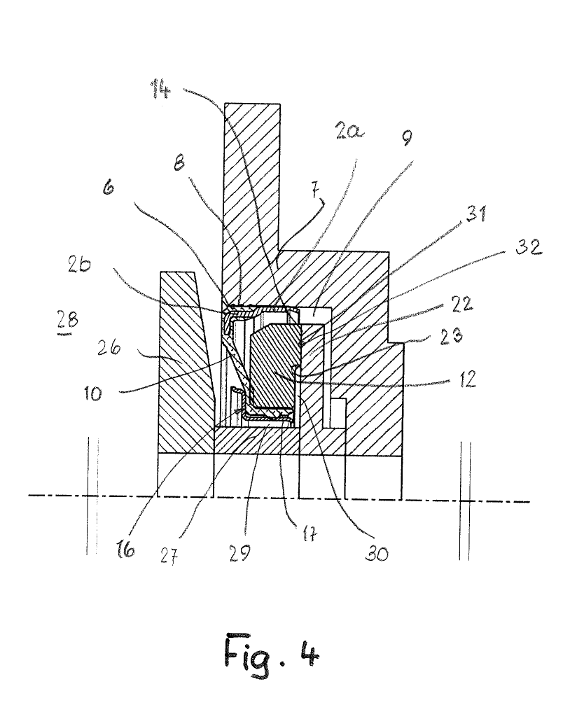

The ring section 2b is covered by a jacket 5 at the inner side and outer side. The jacket 5 is comprised advantageously of elastomeric material. In the region of the ring section 2b, the jacket 5 is advantageously provided at its outer side with a profiling 6 that is advantageously configured to be wavy (corrugated). When the mechanical seal is installed (FIG. 4), the jacket 5 in the region of the ring section 2b provides a static sealing action. When pressing the mechanical seal into a housing 7 associated with the device, the jacket 5 is elastically compressed in radial direction. Due to the advantageous corrugated profiling 6, a flat and areal contact of the jacket 5 at a wall 8 of an installation space 9 in the housing 7 (FIG. 4) results in the installed position as a result of the elastic deformation. The ring section 2a is seated with press fit in the installation space 9.

The jacket 5 covers advantageously also the annular flange 3 at the inner side and the outer side. In this way, the annular flange 3 is also protected by the jacket 5.

It is advantageous when the jacket 5 is formed as one piece (monolithic) together with the membrane 10 that has a cone shape and passes at its radial inner end into a cylindrical sleeve section 11. A sealing ring 12 is seated on the cylindrical sleeve section 11.

At the transition into the sleeve section 11, the membrane 10 is provided with a ring section 13 which is positioned in a radial plane. The sealing ring 12 has an end face 15 arranged opposite the sliding surface 14 and the end face 15 is resting against the ring section 13. The radial width of the ring section 13 is smaller than the radial width of the end face 15 of the sealing ring 12. The radial width of the ring section 13 is advantageously less than half the radial width of the end face 15.

The sleeve section 11 of the membrane 10 surrounds a holding sleeve 16 that is made of metal, a hard plastic material, or composite material.

The free end of the cylinder section 17 of the holding sleeve 16 is advantageously angled at a slant inwardly in radial direction. In this way, a simple assembly of the mechanical seal is enabled.

At the other end, the holding sleeve 16 passes into an annular flange 18 which is extending in radial direction outwardly. Its free end is formed to a cylindrical ring 19 which is approximately positioned at the level of the transition of the ring section 13 into the cone section 20 of the membrane 10. The ring section 13 of the membrane 10 rests flat against the annular flange 18 of the holding sleeve 16 as well as against the end face 15 of the sealing ring 12.

At its inner side, the sleeve section 11 is advantageously provided with a radial inwardly oriented and circumferentially extending projection 21 which, in the installed position, is elastically deformed so that the sleeve section 11 of the membrane 10 is seated fixedly on the cylinder section 17 of the holding sleeve 16. In addition, an adhesive can be employed for providing a fixed connection of the sleeve section 11 at the holding sleeve 16.

The sealing ring 12 projects axially past the sleeve section 11 and the holding sleeve 16. In this way, it is ensured that the sealing ring 12 in the installation position reliably comes into seal-tight contact with a sealing ring 22 (FIG. 4). The sealing ring 22 is seated fixedly on the shaft to be sealed.

In the embodiment, the sealing ring 12 is contacting only about a portion of its radial width the end face 23 of the sealing ring 22 with areal contact. The sliding surface 14 is provided at an axially projecting outer ring region of the sealing ring 12.

The sleeve section 11 of the membrane 10 and the cylinder section 17 of the holding sleeve 16 as well as the radial inner region of the sealing ring 12 have approximately the same axial width. In this way, the sealing ring 12 is safely secured and supported.

The sleeve section 11 of the membrane 10 serves in the installed position as an additional static sealing action of the sealing ring 12 relative to the holding sleeve 16.

At the transition from the end face 15 into the outer cylindrical wall surface 24, the sealing ring 12 is provided with a slanted portion 25 so that the sealing ring 12 is provided with a cone surface in this region. The wall surface 24 of the sealing ring 12 has a radial spacing from the ring part 2 of the housing 1.

In a direction away from the ring section 13, the cone section 20 of the membrane 10 has an increasing spacing relative to the end face 15 of the sealing ring 12.

FIG. 4 shows in an exemplary fashion that the impeller 26 is fixedly seated on the shaft and is arranged at a spacing from the sealing ring 22. An intermediate sleeve 27 is positioned on the shaft between the impeller 26 and the sealing ring 22; the impeller 26 as well as the sealing ring 22 are resting axially against the intermediate sleeve 27.

As can be seen in FIG. 4, the mechanical seal is installed such that the membrane 10 is facing the pressure side or medium side 28. Therefore, the medium in the medium space (28, 30) to be sealed loads the membrane 10 that shields the sealing ring 12 relative to the medium at its end face 15 that is opposite the sliding surface 14.

The cylinder section 17 of the holding sleeve 16 has a radial spacing relative to the intermediate sleeve 27. Between the cylinder section 17 of the holding sleeve 16 and the intermediate sleeve 27, an annular space 29 is formed through which the medium can reach the region between the sealing ring 12 and the sealing ring 22. As a result of the radially recessed end face of the sealing ring 12, a narrow annular medium space 30 is formed between both sealing rings; it is positioned in a radial plane and through it the medium can reach the sealing gap 31 between the sealing ring 12 and the sealing ring 22. The sealing gap 31 is formed between the sliding surface 14 of the sealing ring 12 and the neighboring sliding surface 32 of the sealing ring 22.

Advantageously, in the sliding surface 14 of the sealing ring 12 and/or in the sliding surface 32 of the sealing ring 22 aerodynamically or hydraulically active structures can be present which at corresponding rotary speeds of the shaft generate in air cushion or liquid cushion between the sealing ring 12 and the sealing ring 22 so that an almost friction-free operation of the mechanical seal is possible.

The membrane 10 exerts an axial force on the sealing ring 12 in such a way that the sealing ring 12 is pressed against the sealing ring 22. The membrane 10 is configured such that it exerts an axial force on the sealing ring 12 even without pressure being present at the medium side 28. When the pressure rises at the medium side 28, the cone section 20 of the membrane 10 deforms elastically in the direction toward the sealing ring 12. The cone section 20 contacts tightly the end face 15 of the sealing ring 12. The stronger the pressure that is acting on the cone section 20, the more tightly the cone section 20 contacts the end face 15 due to its elastic deformation.

In the installed position, the gap-closing force F_{S} is acting on the cone section 20 of the membrane 10. The gap-opening force F_{O} is oriented opposite to this gap-closing force F_{S}. In order to close the sealing gap 31, the condition F_{S}>F_{O} must be fulfilled. Otherwise, the sealing gap 31 would open.

The gap-closing force F_{S} is comprised of a static force component caused by positioning the seal in the installed position and of a pressure-caused component.

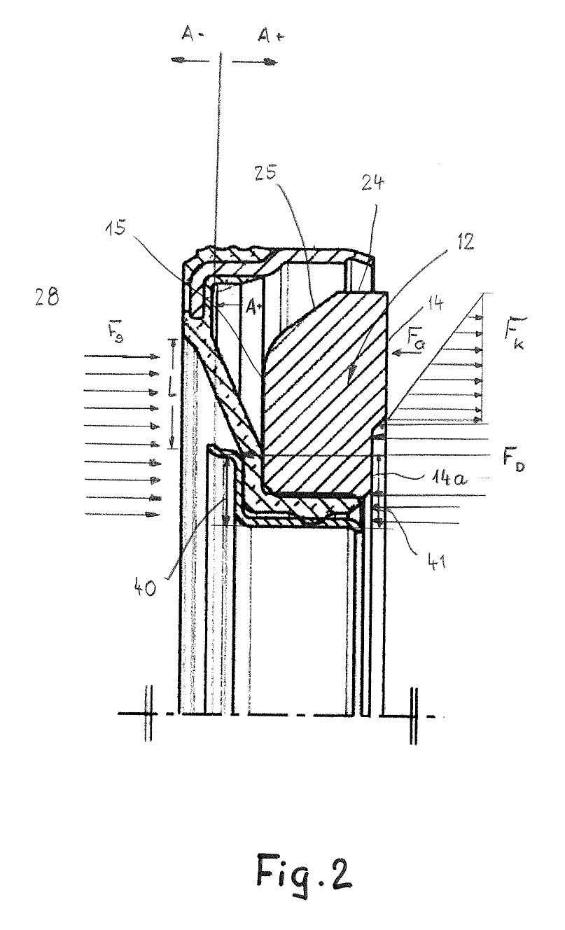

The gap-opening force F_{O} (FIG. 2) is comprised of the force F_{G} which is acting in the sealing gap 31 across the sliding surface 14 and the pressure-caused force F_{D} (F_{O}=F_{G}+F_{D}).

In FIG. 1, the region in which the pressure-caused force component of the force F_{S} is acting on the cone section 20 is identified by the measurement L in the drawing. The radial width of this region is determined by the connection of the cone section 20 to the annular flange 3 as well as the radial outer rim of the annular flange 18 of the holding sleeve 16. Only in this region L, the cone section 20 can be elastically deformed. In the region in which the annular flange 18 of the holding sleeve 16 covers the annular section 13 of the membrane 10, the pressure-caused force F_{S} is compensated by a pressure-caused counter force F_{D} which is of the same magnitude. Due to the identical pressure-active surfaces 40, 41, a force compensation is thus provided.

The sliding surface 14 of the sealing ring 12 and the membrane 10 are configured in relation to each other such that the contact force in the sealing gap 31 at the transition of the sliding surface 14 to the recessed end face section 14a is maximal. In FIG. 2, the contact force F_{K} is indicated which is generated by the gap-closing force F_{S} and is acting at the sliding surface 14 in the sealing gap 31. It can be seen that the contact force F_{K} is greatest in the described transition region from the sliding surface 14 to the annular medium space 30 (FIGS. 2 and 4) and decreases in the radial direction outwardly. Other courses of the contact force are also conceivable. Important is in this context that the contact force F_{K} at the transition of the sliding surface 14 to the annular medium space 30 is maximal and at the transition of the sliding surface 14 to the space that does not contain medium is minimal or even 0. The course of this contact force F_{K} and thus of the contact pressure which is present in the sealing gap 31 can be adjusted by a corresponding shaping of the sealing ring 12 in an application-specific way and is affected directly by the property of the deformable bellows-shaped membrane 10. An important goal is the arrangement and configuration of the membrane 10 in such a way that the maximum contact pressure in the sealing gap 31 at the sliding surface 14 always assumes (i.e., in the static state and under pressure load by the medium) the maximum value of the contact course across the sliding surface 14, as it is illustrated in FIG. 2 in an exemplary fashion, and that the elastic deformation of the cone section 20 enhances or even enables this in any position.

The region of measurement A is indicated in FIG. 1 and refers to the spacing of the jacket 5 from the end face 15.

The gap-closing force F_{S} results as follows:

F_{S}=F_{membrane.stat}−F_{membrane.dyn}+F_{P}

Herein the following applies:
F_{membrane.stat} axial force of the membrane 10 in installed position;
F_{membrane.dyn} axial force component of the membrane 10 in an installed position and under pressure action;
F_{P} axial force component of the pressure-active surface due to pressure loading in the installed position of the mechanical seal.

In the installed position, the pretensioned membrane 10 effects the axial force F_{membrane.stat} that closes the sealing system. The membrane 10 is configured such that the described axial compression between the sealing ring 12 and the sealing ring 22 results in the installed position of the mechanical seal. The membrane 10 acts as an axial spring and forms a secondary sealing element.

In case of pressure loading of the membrane 10 by the medium at the medium side 28, an elastic deformation of the membrane 10 is observed. In this way, in the cone section 20 of the membrane 10 a tensile force is produced whose axial component is the force F_{membrane.dyn}.

By the pressure on the medium side 28, the pressure-dependent force component F_{P} is produced. It results from the pressure-active surface in the region L and the pressure acting on this region.

The pressure-active surface depends on the deformation of the membrane 10 and the configuration of the end face 15 of the sealing ring 12 where the cone section 20 comes into contact.

By the thickness of the cone section 20 of the membrane 10 and/or the membrane material, the magnitude of the deformation and of the force which is acting on the sealing ring 12 can be additionally affected in a targeted fashion.

The measurement A indicates at which force F_{S} the cone section 20 is contacting with elastic deformation the end face 15 of the sealing ring 12 in the installed position. The higher the force F_{S}, the more the cone section 20 contacts the end face 15 of the sealing ring 12. The greater the measurement A is adjusted, the greater the force F_{S} must be for the cone section 20 to contact the end face 15 of the sealing ring 12. When this measurement A in relation to the measurement L is selected too large, the force component F_{membrane.dyn} will be dominant and there is the risk that the seal opens.

An excellent configuration of the membrane 10 with regard to gap-closing force F_{S} results when the following range is observed:

0≤A/L≤2

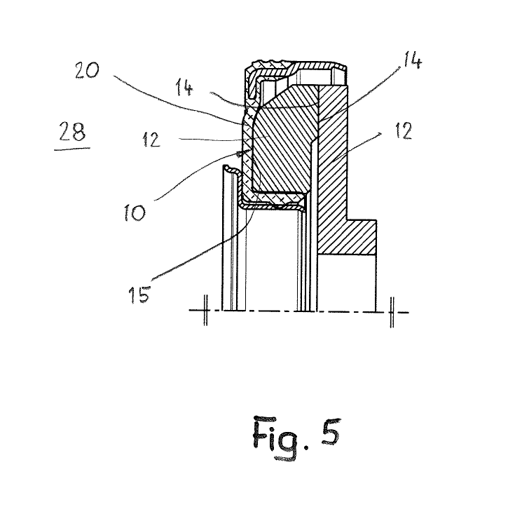

The value for L assumes positive values. The value for A assumes positive values when the measurement A extends in the direction of the sliding surface 14 (FIG. 2) and assumes negative values when the measurement A extends opposite to this direction (FIG. 5).

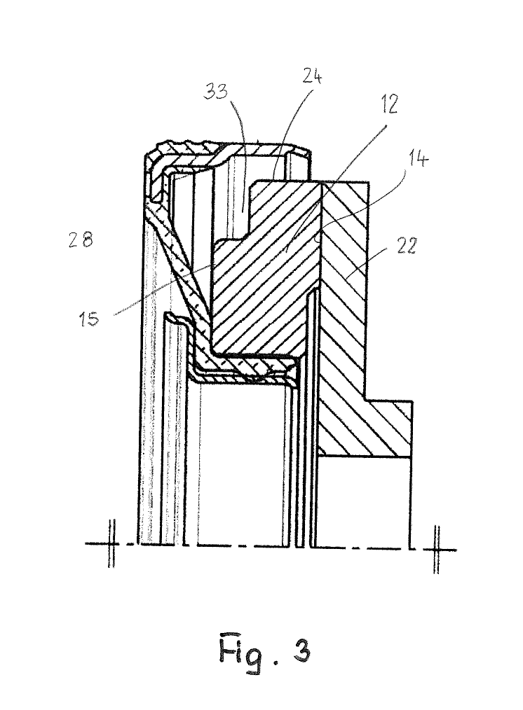

FIG. 2 shows a mechanical seal which is substantially of the same configuration as the mechanical seal of FIG. 1. The difference resides in the configuration of the transition from the end face 15 facing the medium side 28 into the outer wall surface 24 of the sealing ring 12. This transition is formed by the slanted portion 25 which extends across a greater axial region than in the preceding embodiment. In this way, the wall surface 24 is smaller than in the embodiment according to FIG. 1. Also, the radial width of the end face 15 is smaller than in the preceding embodiment. The slanted portion 25 is designed such that it is extending substantially straight, viewed in axial section, across most of its length and then with constant curvature into the end face 15. The measurement A and the effective region L are the same as in the embodiment according to FIG. 1. The measurement A can assume negative values due to this configuration while in the configuration described in FIG. 1 negative values for the measurement A are not possible. Due to this measure, a broader axial range of use with regard to the installed position is enabled. In particular, greater axial movements can be compensated in this way. Moreover, a configuration according to FIG. 2 or 3 prevents contacting of the sealing ring and a displacement of the advantageous pressure distribution F_{K}.

In the embodiment according to FIG. 3, the sealing ring 12 is provided at its end face 15 facing the medium side 28 with an annular groove 33 which is open in the direction toward the wall surface 24 and toward the end face 15. In other respects, this embodiment is of the same configuration as the embodiment of FIG. 1 and has the same advantages as the embodiment according to FIG. 2. By providing the annular groove 33, the sealing ring can be produced in a more simple and less expensive way, in particular by means of a sintering method.

An excellent configuration of the membrane 10 with regard to the gap-closing force F_{S} results for the embodiments according to FIG. 2 and FIG. 3 when the following range is observed:

−0.5≤A/L≤2

FIG. 5 shows the possibility of employing two sealing rings which are arranged such that the sliding surfaces 14 of the two sealing rings 12, 22 are positioned at the same level. These two sealing rings are installed such that their sliding surfaces 14 are congruently resting against each other under pressure.

The housing 1 is installed such that the measurement A assumes negative values. In this case, the cone section 20 in the installed state is resting with elastic deformation at the end face 15 of the sealing ring 12 without the medium pressure having an effect.

In this case, one mechanical seal is fixedly connected to the shaft and the other mechanical seal is fixedly connected to the housing. Both mechanical seals are installed such that the sealing rings 12, 22 are axially pressed against each other. The membrane 10 which is facing the medium side 28 is loaded in the described way with pressure. Depending on the magnitude of this pressure, the cone section 20 of the membrane 10 will deform such that the cone section 20 is contacting the end face 15 of the sealing ring 12.

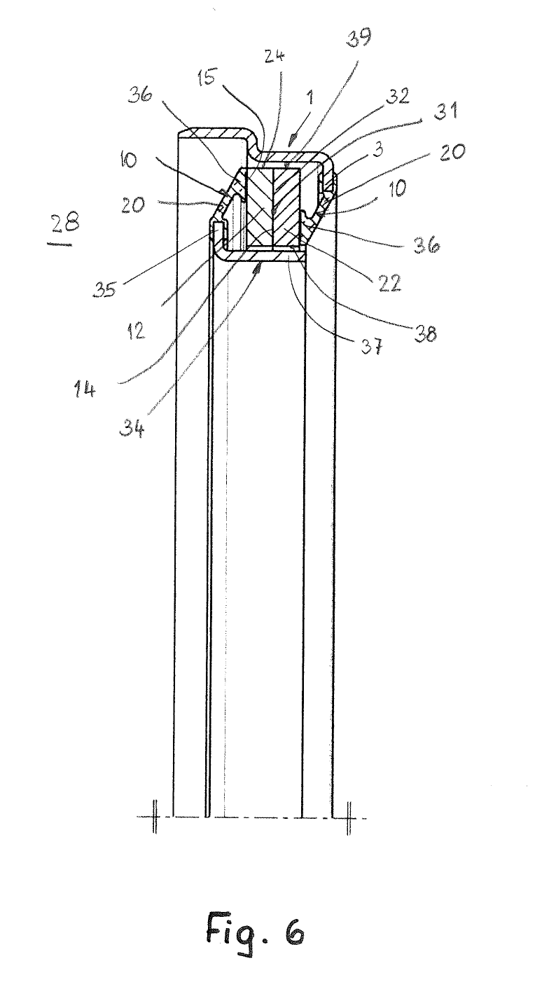

FIG. 6 shows an embodiment in which the mechanical seal comprises the sealing ring 22 as well as the sealing ring 12. Both sealing rings 12, 22 are secured by a respective membrane 10. The two sealing rings 12, 22 have a rectangular cross-section and are positioned with their sealing surfaces under axial force seal-tightly against each other. The sealing ring 22 and the sealing ring 12 can be of the same configuration as shown in FIG. 6. Both sealing rings can however also have different shapes.

The sealing ring 12 is suspended from the membrane 10. The membrane 10 is fastened with its radial inner end at the radial outer annular flange 35 of a fastening sleeve 34 which is seated fixedly on the shaft in the installed position of the mechanical seal. The radial outer end of the membrane 10 is fastened to the end face 15 of the sealing ring 12. In order to ensure a secure connection between the sealing ring 12 and the membrane 10, the connecting region 36 of the membrane 10 is of a wider configuration. In this way, the sealing ring 12 can be connected across a relatively large connecting region 36 reliably to the membrane 10. The attachment of the membrane 10 at the end face 15 of the sealing ring 12 can be realized in any suitable way, for example, by an adhesive connection.

The sealing ring 22 is fastened stationarily by means of a further membrane 10. The radial inner end of the membrane 10 is widened and forms the connecting region 36 that, as in case of the sealing ring 12, is extending about the circumference and, due to the widened portion, ensures a reliable attachment of the sealing ring 22 at the membrane 10. The radial outer end of the membrane 10 is fastened at the radial flange 3 of the housing 1 that is oriented inwardly in radial direction. It surrounds the two sealing rings 12, 22 at a radial spacing. The two sealing rings in turn surround the fastening sleeve 34 at a spacing.

The fastening sleeve 34 has a cylindrical ring section 37 which projects slightly axially past the sealing ring 22 and, at the other end, is provided with the radially outwardly oriented annular flange 35.

The two membranes 10 are positioned displaced relative to each other in such a way that the connecting region 36 of the first membrane 10 extends to the level of the outer wall surface 24 of the sealing ring 12 and the connecting region 36 of the second membrane 10 extends to the level of the radial inner cylindrical wall surface 38 of the sealing ring 22.

Since the sealing ring 12 is connected by the membrane 10 to the fastening sleeve 34, which in turn is fixedly seated on the shaft, the sealing ring 12 can rotate in the installed position of the mechanical seal. The sealing ring 22 is connected by the membrane 10 with the housing 1 and remains thus stationary.

As has been explained, the membrane 10 exerts an axial force on the sealing ring 22 which thereby is forced axially against the sealing ring 12. In contrast to the preceding embodiments, the sliding surface 14 of the sealing ring 12 extends across the entire radial width. Since the sealing ring 12 and the sealing ring 22 are of the same configuration, the two sliding surfaces 14 and 32 of the sealing ring 12 and of the sealing ring 22 have the same radial width.

The membrane 10 which is facing the medium side 28 is elastically deformed by the pressure of the medium in the described way such that its cone section 20, depending on the magnitude of the pressure, deforms more or less strongly in the direction of the end face 15 of the sealing ring 12. When in this embodiment the force component F_{membrane.dyn} is dominant so that the seal in the arrangement according to FIG. 1 would open, in the embodiment according to FIG. 6 the sealing ring 22 follows the movement of the sealing ring 12. The sealing function remains intact. Even in case of a pressure reversal or a vacuum at the medium side 28, the function is fulfilled reliably. In this case, the membrane 10 which is facing away from the medium side 28 and is wetted by the medium at the inner side is elastically deformed in such a way by the vacuum or pressure reversal in the described way such that its cone section 20, depending on the magnitude of the pressure, more or less strongly is deformed in the direction of the sealing ring 22.

Between the two rings 12, 22 and the housing 1, an annular space 39 is provided through which the medium can flow to the sealing gap 31 between the sealing ring 12 and the sealing ring 22.

The mechanical seal according to FIG. 6 has the same effect as the mechanical seal according to FIG. 1.

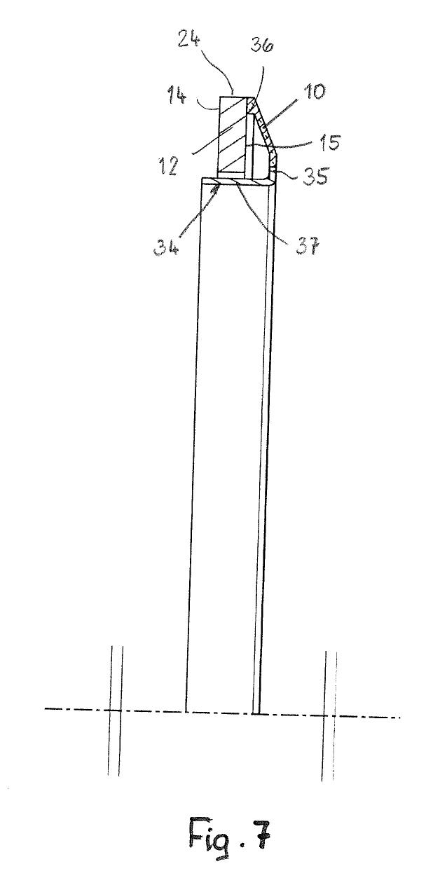

FIG. 7 shows the possibility of attaching the sealing ring 12 in suspended manner to the membrane 10. The thicker connecting region 36 of the membrane 10 is positioned at the radial outer rim of the end face 15 of the sealing ring 12. As in the preceding embodiment, the connecting region 36 extends up to the level of the outer wall surface 24 of the sealing ring 12.

The radial inner end of the membrane 10 is fastened to the radial outwardly oriented annular flange 35 of the fastening sleeve 34. The sealing ring 12 surrounds at a spacing the cylindrical ring section 37 of the fastening sleeve 34.

In the exemplary embodiment, the sealing ring 12 has a rectangular cross section wherein the two end faces 15, 14, in accordance with the preceding embodiment, are positioned in a radial plane, respectively.

The diameter of the conical membrane 10 decreases from the connecting region 36 in the direction toward the annular flange 35.

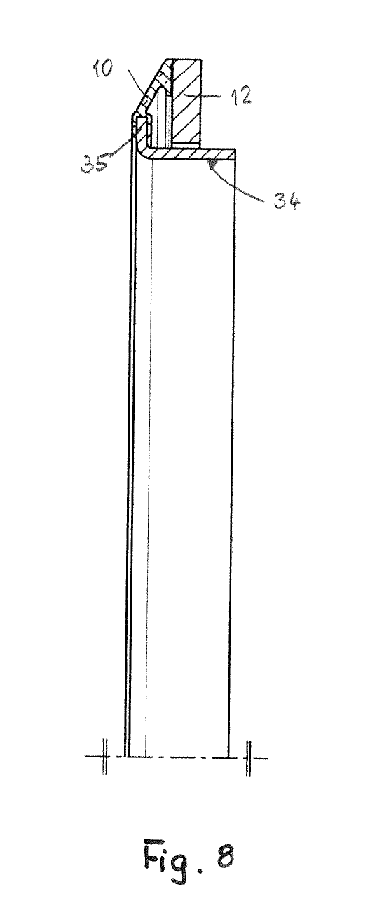

In the embodiment according to FIG. 8, the sealing ring 12 is also attached in a suspended manner to the membrane 10. The difference to the preceding embodiment resides only in that the connection of the membrane 10 at the annular flange 35 of the fastening sleeve 34 is designed such that the fastening region engages the annular flange 35 on both sides.

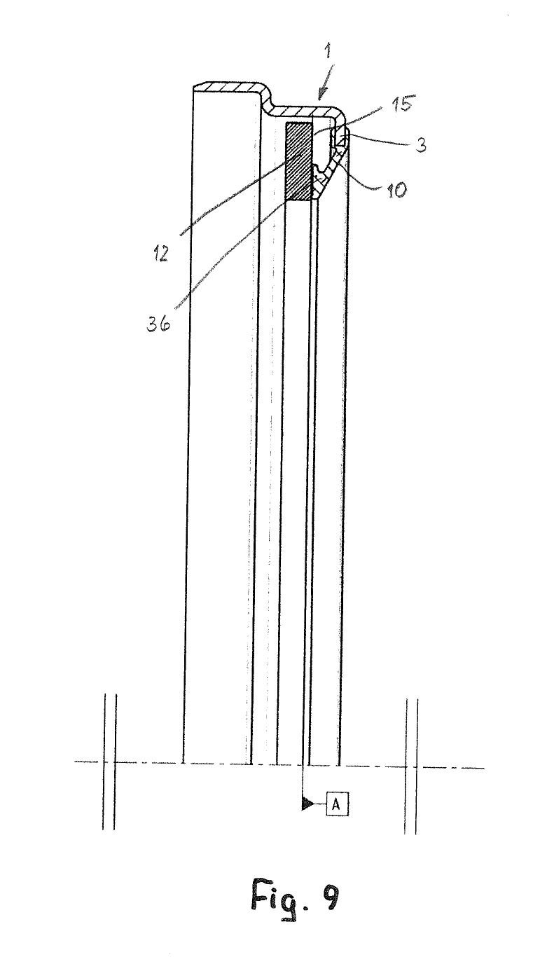

FIG. 9 shows in an exemplary fashion the possibility of connecting the sealing ring 12 also stationarily to the membrane 10. In this case, the connecting region 36 of the membrane 10 is located in the radial inner region of the end face 15 of the sealing ring 12. The other end of the membrane 10 is fastened to the radial inwardly oriented annular flange 3 of the housing 1. The housing 1 surrounds at a radial spacing the sealing ring 12.

In the described embodiments, the membrane 10 generates, at minimal or no pressure at the medium side 28, an axial force which is acting on the sealing ring 12 and supports it in seal-tight contact at the sealing ring 22. When the pressure at the medium side 28 increases, the membrane 10 will be increasingly more strongly deformed elastically in the described way. Due to the targeted deformation of the membrane 10 at increasing pressure, this leads to an operatively beneficial ratio between gap-opening forces Fₒ and gap-closing forces F_{S}.

The mechanical seals are advantageously gas-lubricated or liquid-lubricated so that already at low rotary speeds a separation of the two sliding partners 12, 22 occurs and also at increasing or higher operating pressures at the medium side 28 a stable gap opening is achieved. The structures which are required for this gas/liquid lubrication can be provided in the sliding surface 14 of the sealing ring 12 and/or in the sliding surface 32 of the sealing ring 22.

In order to be able to adjust the ratio between the gap-opening and the gap-closing forces, the membrane 10 can be configured in a targeted fashion. As decisive criteria, the cone angle of the membrane 10, the size of the region L, the thickness of the membrane 10, and the material of the membrane 10 can be utilized. These parameters taken alone, but also in combination, and in relation to each other can be adjusted optimally such that the desired advantageous ratio between the gap-opening and the gap-closing forces is achieved.

For example, by the size of the measurement L, it can be determined whether the membrane 10 can be elastically deformed easily or with difficulty at corresponding forces. When the region (L) is relatively small, the membrane 10 has a greater stiffness than in case of a larger measurement L. The thickness of the membrane 10 has also an effect on the stiffness. The thinner the membrane 10, the easier it can be deformed at a given pressure. Also, the material of the membrane 10 has an effect on the elasticity of the membrane 10. Accordingly, with a smart selection of these different parameters, the degree to which the membrane 10 can be elastically deformed at different pressures acting at the medium side 28 can be determined.

Moreover, by these parameters it can be determined how large the tensile load in the cone section 20 of the membrane 10 is.

Also, with an appropriate selection of the aforementioned parameters, it can be determined how great the forces are which are acting on the connection between the membrane 10 and the sealing ring 12.

By means of the configuration according to the invention, it is possible to achieve the separation of the sliding surfaces from each other not only at higher but also at lower rotary speeds of the shaft. Also, as a result of the described configuration, a high pressure stability at high rotary speeds can be ensured. High pressures at the medium side 28 do not cause damage at the membrane 10 or at the connecting location of the membrane 10 and sealing ring 12.

With a targeted configuration of the end face 15 of the sealing ring 12, the pressure-dependent force path can be positively affected. Examples therefor are shown in FIGS. 1 to 3 in which the end face 15 as well as its transition to the wall surface 24 are designed differently.

In the embodiments according to FIGS. 1 to 3, disadvantages due to the deformation of the membrane 10 are compensated by the clamping or holding sleeve 16 upon pressure loading at the inner side of the membrane 10.

The connection between the membrane 10 and the sealing ring 12 or the sealing ring 22 can be realized with form fit, material fusion, or friction. The use of the clamping sleeve (holding sleeve) 16 is particularly advantageous. The annular flange 18 of the clamping sleeve 16 prevents in case of pressure loading of the membrane 10 at its outer side that the connection between the sealing ring 12 and the sealing ring 22 is tensile-loaded.

The specification incorporates by reference the entire disclosure of German priority document 10 2017 012 105.2 having a filing date of Dec. 21, 2017.

While specific embodiments of the invention have been shown and described in detail to illustrate the inventive principles, it will be understood that the invention may be embodied otherwise without departing from such principles.

What is claimed is:

1. A mechanical seal comprising:
a first sealing ring comprising a sliding surface and configured to contact with the sliding surface a second sealing ring to form a sealing gap;
an elastically deformable membrane connected to the first sealing ring at a first connecting location and covering an end face of the first sealing ring;
wherein the membrane has a side facing away from the first sealing ring and facing a medium space to be sealed, wherein the side facing away from the first sealing ring and facing the medium space is loaded by a pressure in the medium space;
wherein the membrane comprises a cone section, wherein the cone section adjoins the first connecting location;
wherein the cone section, in an unloaded state, comprises an axial spacing relative to the end face of the first sealing ring such that the cone section by an elastic deformation contacts more or less, as a function of the pressure in the medium space, the end face of the first sealing ring so that a ratio between a gap-opening force and a gap-closing force relative to each other is adjusted at the sealing gap.

2. The mechanical seal according to claim 1, wherein the membrane, in a pressureless state of a medium in the medium space, exerts a first force such that a contact force acting on the sliding surface is maximal at a transition region of the sliding surface into the medium space.

3. The mechanical seal according to claim 2, wherein the membrane is elastically deformed by the pressure in the medium space such that the membrane exerts a second force such that the contact force acting on the sliding surface is maximal at the transition region of the sliding surface into the medium space.

4. The mechanical seal according to claim 1, wherein the membrane comprises a region of greatest diameter and the membrane is connected with the region of greatest diameter to the first sealing ring.

5. The mechanical seal according to claim 1, wherein the membrane comprises a region of smallest diameter and the membrane is connected with the region of smallest diameter to the first sealing ring.

6. The mechanical seal according to claim 1, further comprising a clamping sleeve, wherein the membrane is connected by the clamping sleeve to the first sealing ring.

7. The mechanical seal according to claim 1, wherein the membrane is connected to the end face of the first sealing ring, wherein the end face is opposite the sliding surface.

8. The mechanical seal according to claim 7, wherein the membrane is connected to a radial outer region of the end face or to a radial inner region of the end face.

9. The mechanical seal according to claim 1, wherein the first sealing ring extends away from the first connecting location of the membrane in a radial direction outwardly.

10. The mechanical seal according to claim 1, wherein the first sealing ring extends away from the first connecting location of the membrane in a radial direction inwardly.

11. The mechanical seal according to claim 1, wherein the membrane connects at a second connecting location the first sealing ring to a housing or to a holding part.

12. The mechanical seal according to claim 11, wherein the cone section of the membrane extends between the first connecting location and the second connecting location.

13. The mechanical seal according to claim 11, wherein a first region between the first connecting location and the second connecting location determines an elastic deformability of the membrane.

14. The mechanical seal according to claim 13, wherein a measurement (L) of the first region and a measurement (A) of a second region defined by the axial spacing are in a first range defined by 0≤A/L≤2 or in a second range defined by −0.5≤A/L≤2.

15. The mechanical seal according to claim 1, wherein the axial spacing determines an elastic deformability of the membrane.

16. The mechanical seal according to claim 1, wherein the sliding surface is arranged opposite the end face, wherein the end face is configured such the axial spacing can assume negative values.

17. The mechanical seal according to claim 1, an elastic deformability of the membrane is determined by one or more features selected from the group consisting of a cone angle of the cone section of the membrane; a thickness of the membrane; and a material of the membrane.

18. The mechanical seal according to claim 1, further comprising a second sealing ring arranged facing the sliding surface of the first sealing ring.

19. The mechanical seal according to claim 18, wherein aerodynamic or hydrodynamic effective structures are introduced into at least one of the first and second sealing rings.

20. The mechanical seal according to claim 1, wherein the end face of the first sealing ring facing away from the sliding surface passes by a slanted portion or by a step into an outer wall surface of the first sealing ring.

21. A device comprising a medium space sealed by a mechanical seal according to claim 1.
